(19) United States
(12) Patent Application Publication
(10) Pub. No.: US 2015/0165878 A1
(43) Pub. Date: Jun. 18, 2015

(54) APPARATUS FOR PREVENTING DROOP OF BLIND FOR PANORAMA SUNROOF

(71) Applicant: Hyundai Motor Company, Seoul (KR)

(72) Inventor: In Seok Kang, Incheon (KR)

(73) Assignee: Hyundai Motor Company, Seoul (KR)

(21) Appl. No.: 14/272,087

(22) Filed: May 7, 2014

(30) Foreign Application Priority Data
Dec. 13, 2013 (KR) 10-2013-0155487

(51) Int. Cl. B60J 3/02

(52) U.S. Cl. CPC B60J 3/0213

(57) ABSTRACT

A mechanism for preventing a blind from sagging may include a support rod integrally combined with the blind and disposed transversely with respect to a longitudinal direction of a vehicle, guide blocks coupled to ends of the support rod, and block guide grooves formed on guide rails to guide the guide blocks to move in longitudinal directions of the guide rails and to enable the guide blocks to move inward from sides of the vehicle when the blind is unrolled and drawn out from a shaft to block the sunlight.

### CROSS-REFERENCE TO RELATED APPLICATION

The present application claims priority of Korean Patent Application Number 10-2013-0155487 filed on Dec. 13, 2013, the entire contents of which application are incorporated herein for all purposes by this reference.

### BACKGROUND OF INVENTION

1. Field of Invention

The present invention relates to a mechanism for preventing a blind for a panorama sunroof from drooping or sagging, and more particularly to a mechanism for preventing a blind for a panorama sunroof from drooping or sagging which prevents the reduction of a headroom by preventing a blind made of cloth from sagging when a roller blind is closed.

2. Description of Related Art

Panorama sunroofs of vehicles which are wholly made of glass are equipped with a blinding device for blocking the sunlight, in which ones with the blind formed in a panel type have a problem with the layout, so they are less used, but roll blind devices with the blind made of cloth are generally used.

A roll blind device has a blind 2 made of cloth and wound around a shaft 1, as shown in FIGS. 1 and 2, in which when the blind 2 is closed to block the sunlight, the blind 2 is opened straight, so there is a problem in that a relatively large space 4 is caused between a roof glass 3 and the blind 2 and the headroom is reduced by the open structure.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a mechanism for preventing a blind for a panorama sunroof from drooping or sagging, which can prevent a blind from drooping or sagging due to upward movement of the blind to a roof glass when closing the blind, which is made of cloth, to block the sunlight and can prevent the reduction of the interior headroom by reducing the empty space caused between the roof glass and the blind.

A mechanism for preventing a blind for panorama sunroof from drooping or sagging according to the present invention may include a support rod integrally combined with the blind and disposed transversely with respect to a longitudinal direction of a vehicle, guide blocks coupled to ends of the support rod, and block guide grooves formed on guide rails to guide the guide blocks to move in longitudinal directions of the guide rails and to enable the guide blocks to move inward from sides of the vehicle when the blind is unrolled and drawn out from a shaft to block the sunlight.

The support rod may be an elastic rod capable of bending elastically. The support rod may include a plurality of links connected by a rotary shaft, and the links may rotate such that the rotary shaft protrudes only upward toward a roof glass when an external force is applied.

A respective guide rail in the guide rails may include an upper bracket and lower bracket connected in a U-shape to make an inner groove open inward toward the blind, and a corresponding block guide groove in the block guide grooves may be formed at the lower bracket in the front-rear direction that is the longitudinal direction of the guide rails.

The block guide groove may have an inlet open rearward and an extension extending straight in the front-rear direction ahead of the inlet, and the extension may be formed inside more than the inlet and the inlet and the extension are connected by a bending portion.

An inner protrusion, which prevents the guide block from coming out of the block guide groove by limiting upward movement of the guide block when the guide block is inserted into the inlet of the block guide groove, may protrude on the upper bracket of the guide rails toward the lower bracket and extend in the front-rear direction which is the longitudinal direction of the guide rails.

An outer protrusion, which prevents the guide block from coming out of the block guide groove by limiting upward movement of the guide block when the guide block is inserted into the extension of the block guide groove, may protrude on the upper bracket of the guide rails toward the lower bracket and extend in the front-rear direction which is the longitudinal direction of the guide rails.

When the guide block is inserted into the inlet of the block guide groove and positioned in the extension by forward movement of the blind, the support rod may bend upward and bring the blind in close contact with the roof glass.

According to the present invention, since when the blind made of cloth is unrolled and drawn out (closed) from the shaft to block the sunlight, the blind moves upward and comes in close contact with the roof glass, drooping or sagging of the blind can be prevented and accordingly the empty space generated between the roof glass and the blind can be reduced. Therefore, it is possible to use a wider headroom space in the interior.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a plan view of a panorama sunroof;

FIG. 2 is a cross-sectional view taken along the line I-I of FIG. 1 for illustrating a roller blind device for a panorama sunroof according to a structure of the related art;

FIG. 3 is a perspective view of an exemplary roller blind device for a panorama sunroof equipped with a mechanism for preventing a blind from drooping or sagging according to the present invention;

FIG. 4 is a cross-sectional view taken along the line II-II of FIG. 3;

FIG. 5 is a view illustrating an exemplary support rod according to the present invention;

FIG. 6 is a view illustrating an exemplary block guide groove according to the present invention;

FIG. 7A is a view when the guide block according to the present invention is inserted into the inlet of the block guide groove;

FIG. 7B is a cross-sectional view taken along the line A-A of FIG. 7A;

FIG. 8A is a view when the guide block according to the present invention is positioned on an extension;

FIG. 8B is a cross-sectional view taken along the line B-B of FIG. 8A; and

FIG. 9 is a view illustrating a state with an exemplary blind in close contact with the roof glass by the mechanism for preventing a blind from drooping or sagging according to the present invention.

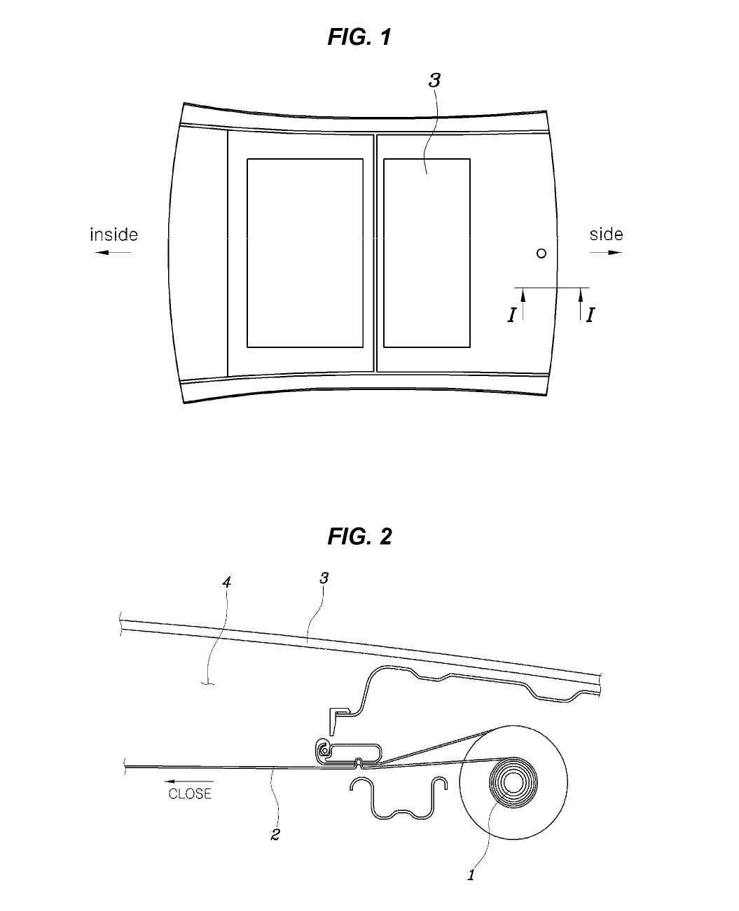

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A roller blind device for a panorama sunroof includes a shaft 20 wound with a blind 10 made of cloth, a blind bar 30 integrally coupled to the free end of the blind 10, blind shoes 40 integrally coupled to both ends of the blind bar 30, and a pair of left and right guide rails 50 guiding the blind shoes 40 to move forward/backward.

The shaft 20 is disposed transversely on a car body and can rotate and it can be reversed too by a spring.

The blind 10 is made of fabric such as cloth, with one end integrally coupled to the shaft 20 and the other end integrally coupled to the blind bar 30.

The guide rails 50 are disposed in the front-rear direction in a pair at the left and right sides of the blind bar 30 and include an upper bracket 51 and a lower bracket 52 connected in a U-shape, and inner grooves 53 open inward toward the blind 10 are formed between the upper bracket 51 and the lower bracket 52.

The blind shoes 40, which are flat or substantially flat blocks, are inserted into the inner grooves 53 of the guide rails 50 and can move forward/backward along the inner grooves 53 to close the blind 10 (draw out it from the shaft to block the sunlight) and open the blind 10 (roll it around the shaft).

The mechanism for preventing a blind from drooping or sagging according to the present invention includes a support rod or support rods 60 integrally combined with the blind 10 and disposed transversely with respect to a longitudinal direction of a vehicle, guide blocks 70 coupled to the ends of the support rods 60, and block guide grooves 80 formed on the guide rails 50 to guide the guide blocks 70 to move in the longitudinal directions of the guide rails 50 and to enable to move the guide blocks 70 inward from sides when the blind 10 is unrolled and drawn out from the shaft 20 to block the sunlight.

The support rod 60 may be an integral elastic rod that can elastically bend, in accordance with various embodiments.

The support rod 60 may be composed of a plurality of links 62 connected by a rotary shaft 61 in accordance with various embodiments, in which the links 62 may rotate such that the rotary shaft 61 protrudes only upward toward a roof glass 90 when an external force is applied, and for this configuration, a stopper 63 such as a hinge may be integrally coupled to the portion where the rotary shaft 61 is coupled.

The guide rails 50 include, as described above, the upper bracket 51 and the lower bracket 52 connected in a U-shape to make the inner grooves 53 open inward and the block guide groove 80 is formed at the lower bracket 52 in the front-rear direction that is the longitudinal direction of the guide rails 50.

The block guide groove 80 according to the present invention has an inlet 81 open rearward and an extension 82 extending straight in the front-rear direction ahead of the inlet 81. Further, the extension 82 is positioned inside more than the inlet 81, and the inlet 81 and the extension 82 are connected by a bending portion 83 having a predetermined curvature.

An inner protrusion 51a, which prevents the guide block 70 from coming out of the block guide groove 80 by limiting upward movement of the guide block 70 when the guide block 70 is inserted into the inlet 81 of the block guide groove 80, protrudes on the upper bracket 51 of the guide rails 50 toward the lower bracket 52 and extends in the front-rear direction which is the longitudinal direction of the guide rails 50.

An outer protrusion 51b, which prevents the guide block 70 from coming out of the block guide groove 80 by limiting upward movement of the guide block 70 when the guide block 70 is inserted into the extension 82 of the block guide groove 80, protrudes on the upper bracket 51 toward the lower bracket 52 and extends in the front-rear direction which is the longitudinal direction of the guide rails 50.

When the guide block 70 is inserted into the inlet 81 of the block guide groove 80 and positioned in the extension 82 by forward movement of the blind 10, the support rod 60 elastically bends upward such that the blind 10 comes in close contact with the roof glass 90.

Further, as the blind 10 is moved backward to be rolled around the shaft 20, the guide block 70 moves to the inlet 81 from the extension 82 of the block guide groove 80, in which the support rod 60 returns the shape to be straight form from its shape bending upward.

The operation of various embodiments of the present invention is described hereafter.

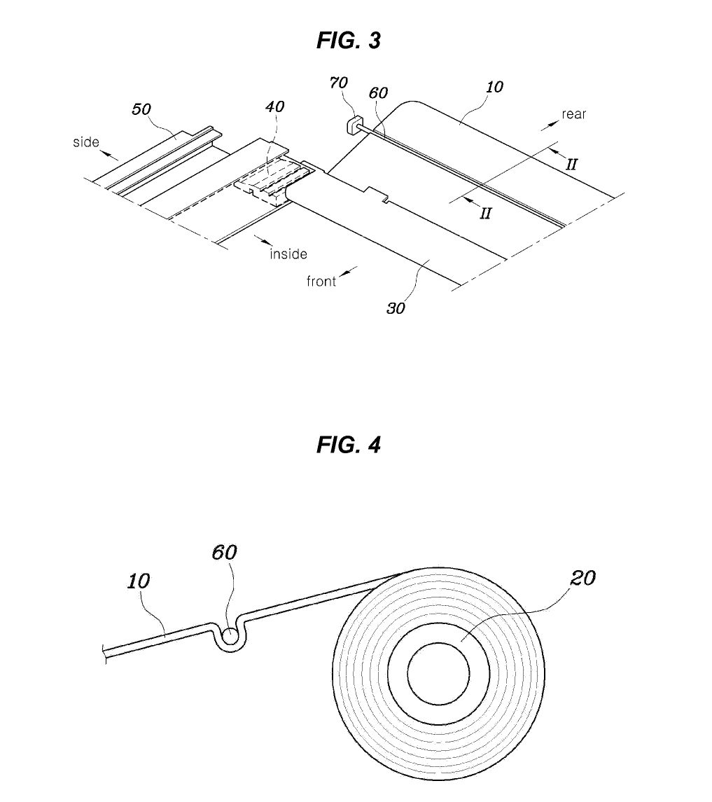

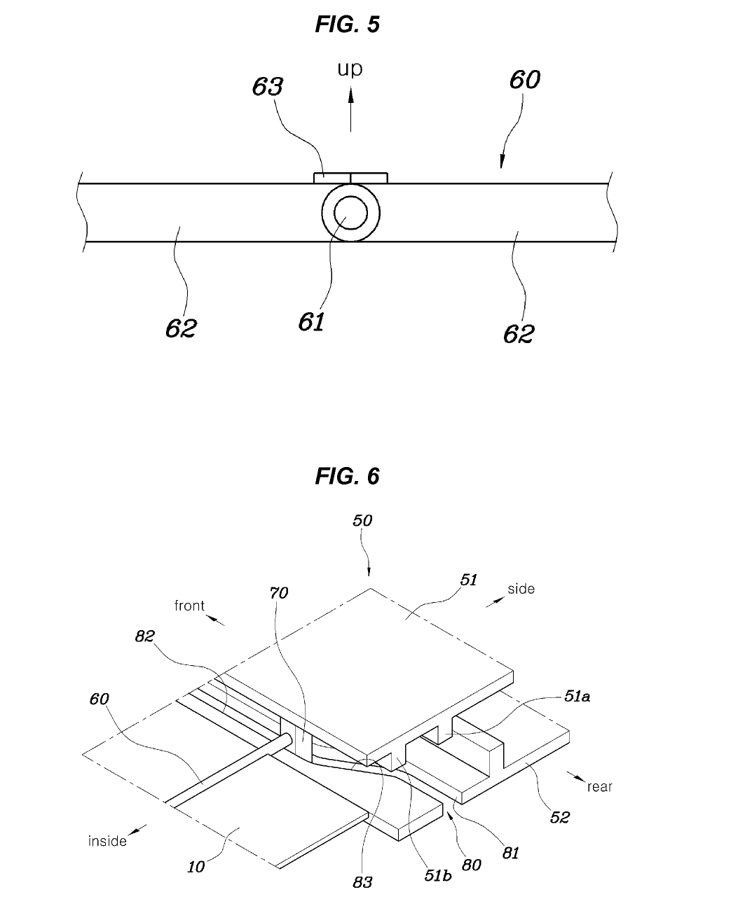

The blind 10 made of cloth has been rolled around the shaft 20 in the initial state in FIG. 3, in which only the blind shoe 40 is in the inner groove 53 of the guide rail 50 and the guide block 70 is not in the inner groove 53 of the guide block 50.

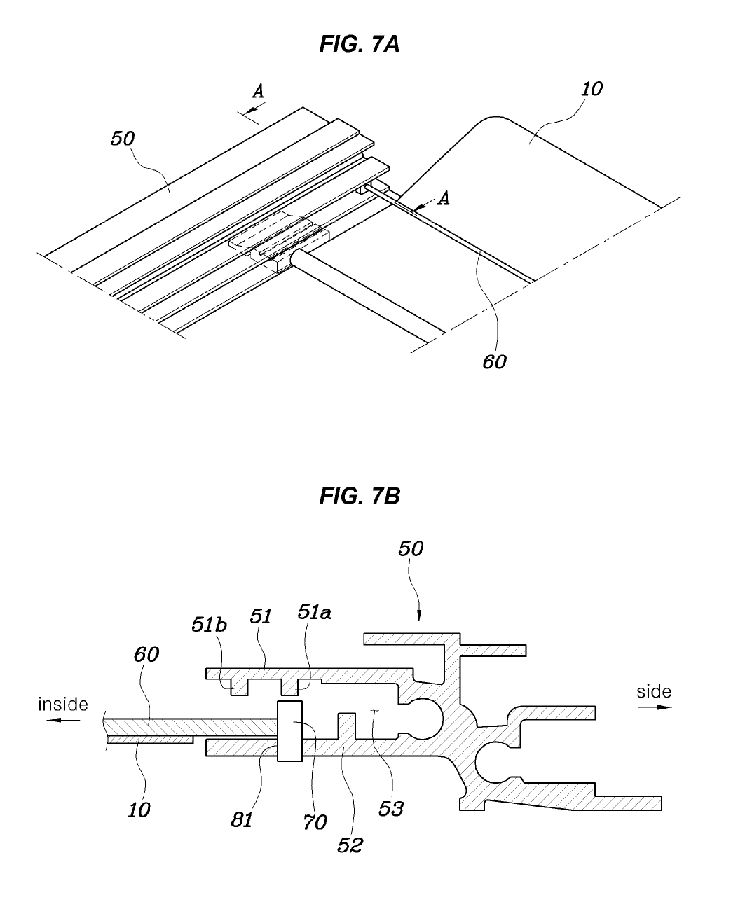

As the blind bar 30 is moved forward in the state described above, the blind 10 is unrolled from the shaft 20 and drawn forward and the guide block 70 is inserted into the inlet 81 of the block guide groove 80, as in FIGS. 7A and 7B.

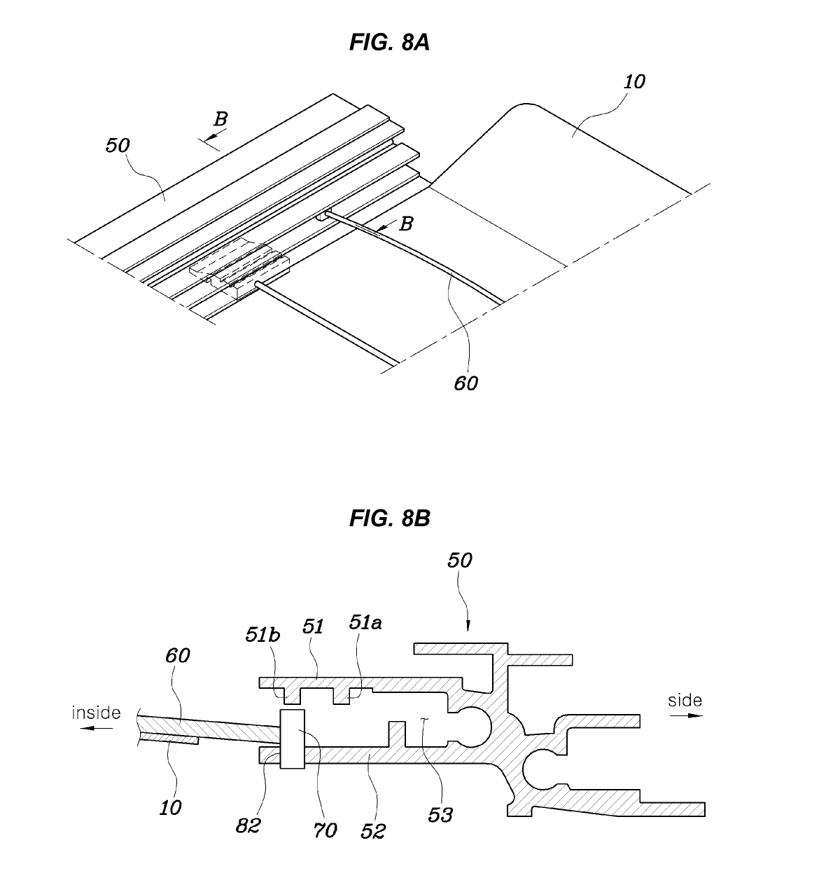

Further, when the blind bar 30 keeps moving forward and the guide block 70 is positioned in the extension 82 through the inlet 81 of the block guide groove 80, as in FIGS. 8A and 8B, the distance between the left and right guide blocks 70 coupled to both ends of the support rod 60 reduces and the support rod 60 elastically bends upward toward the roof glass 90 due to the change in position of the guide block 70.

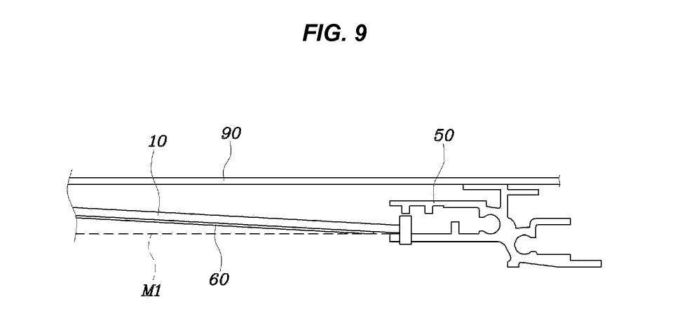

Therefore, the blind 10 coupled to the support rod 60 also moves upward toward the roof glass 90 and comes in close contact with the roof glass 90, as in FIG. 9, so the blind 10 made of cloth does not sag and the empty space between the roof glass 90 and the blind 10 can be reduced; therefore, it is possible to prevent the interior headroom from reducing.

The line “M1” indicated by a dotted line in FIG. 9 is the point where the blind 10 is positioned when the mechanism for preventing sagging according to the present invention is not used, and it can be seen that the blind 10 made of cloth has been moved upward toward the roof glass 90 by the mechanism for preventing sagging according to the present invention, shown in the figure, so it is possible to use an interior headroom wider than those of the related art.

According to various embodiments of the present invention as described above, since the blind 10 is moved upward and brought in close contact with the roof glass 90 by the support rod 60 bending, when the blind 10 made of cloth to block the sunlight is unrolled and drawn out (closed) from the shaft 20, it is possible to prevent the blind 10 from sagging and reduce the empty space generated between the roof glass 90 and the blind 10. Therefore, it is possible to prevent the interior headroom from reducing.

For convenience in explanation and accurate definition in the appended claims, the terms “upper” or “lower”, “front” or “rear”, “left” or “right”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mechanism for preventing a blind from sagging, comprising:
a support rod integrally combined with the blind and disposed transversely with respect to a longitudinal direction of a vehicle;
guide blocks coupled to ends of the support rod; and
block guide grooves formed on guide rails to guide the guide blocks to move in longitudinal directions of the guide rails and to enable the guide blocks to move inward from sides of the vehicle when the blind is unrolled and drawn out from a shaft to block the sunlight.

2. The mechanism of claim 1, wherein the support rod is an elastic rod capable of bending elastically.

3. The mechanism of claim 1, wherein the support rod comprises a plurality of links connected by a rotary shaft, and
the links rotate such that the rotary shaft protrudes only upward toward a roof glass when an external force is applied.

4. The mechanism of claim 1, wherein a respective guide rail in the guide rails includes an upper bracket and lower bracket connected in a U-shape to make an inner groove open inward toward the blind, and
a corresponding block guide groove in the block guide grooves is formed at the lower bracket in a front-rear direction that is the longitudinal direction of the guide rail.

5. The mechanism of claim 4, wherein the block guide groove has an inlet open rearward and an extension extending straight in the front-rear direction ahead of the inlet, and
the extension is formed inside more than the inlet, and the inlet and the extension are connected by a bending portion.

6. The mechanism of claim 5, wherein an inner protrusion, which prevents the guide block from coming out of the block guide groove by limiting upward movement of the guide block when the guide block is inserted into the inlet of the block guide groove, protrudes on the upper bracket toward the lower bracket and extends in the front-rear direction which is the longitudinal direction of the guide rails.

7. The mechanism of claim 5, wherein an outer protrusion, which prevents the guide block from coming out of the block guide groove by limiting upward movement of the guide block when the guide block is inserted into the extension of the block guide groove, protrudes on the upper bracket toward the lower bracket and extends in the front-rear direction which is the longitudinal direction of the guide rails.

8. The mechanism of claim 5, wherein when the guide block is inserted into the inlet of the block guide groove and positioned in the extension by forward movement of the blind, the support rod bends upward and brings the blind in close contact with a roof glass.
